(19) United States
(12) Patent Application Publication
(10) Pub. No.: US 2016/0366857 A1
(43) Pub. Date: Dec. 22, 2016

(54) PET COLLAR HAVING INTEGRATED AUDIO PLAYBACK SYSTEM

(71) Applicant: Alfred Polk, Dallas, TX (US)

(72) Inventor: Alfred Polk, Dallas, TX (US)

(21) Appl. No.: 14/741,947

(22) Filed: Jun. 17, 2015

(51) Int. Cl. A01K 27/00

(52) U.S. Cl. CPC A01K 27/009; A01K 27/001

(57) ABSTRACT

A pet collar having an integrated audio playback system for easing the manner in which identification concerning a pet can be stored and retrieved. The audio message pet collar includes collar body constructed in substantially the same manner and of substantially the same materials as a conventional dog collar except that it includes an integrated electronics housing and speakers system. The electronics housing defines a waterproof case which includes a manually engagable electrical switch, a microphone, a controller, battery, sound card, and memory module. The controller is configured to, upon various engagements of the switch, enter a record mode or enter a playback mode, thereby enabling a pet caretaker to record desired information on the audio message pet collar, which subsequently be directly and quickly availed through an audible message to another in the event the pet is lost.

### BACKGROUND OF THE INVENTION

Field of the Invention

This invention relates generally to animal husbandry and, more particularly, to a pet collar that includes an audible message recording and playback system integral therewith.

Description of the Prior Art

On the most basic level, pet care requires maintaining custody and/or keeping track of the location of one's pet. Despite this, it is inevitable that pets will sometimes become separated from their owner. The use of implantable microchips which include information relating to a pet's identity, home, or owner is a well recognized manner to improve the recovery of lost pets in the event they are lost from the owner. Similarly, as it is well known that many pets wear collars all or most of the time, use of the collar to attach identification or other informational tags is well established to ease the processes of allowing a lost pet to be returned to their owner.

When it comes to recovering lost pets, a problem which still exists is that existing solutions for the same are generally inconvenient and unreliable. Implanted microchips are often difficult to have scanned/read and tags which have been attached to a collar are prone to falling off Thus, there remains a need for a pet collar having an integrated audio playback system which would allow the playback of a informational message directly from the collar of a pet by any person who came across the pet. It would be helpful if such an audio message pet collar allowed customized messages for playback to be selectively recorded by users so that playback could be customized over time. It would be additionally desirable for such an audio message pet collar to include operative components which were built into the collar body, as opposed to being merely attached thereto.

The Applicant's invention described herein provides for a pet collar having an integrated audio playback system adapted to a person who finds a lost pet to directly and reliably ascertain identification information concerning the animal. The primary components in Applicant's audio message pet collar are a collar body, an electronics housing, and a speaker system. When in operation, the audio message pet collar enables more effective and efficient identification on lost animals. As a result, many of the limitations imposed by prior art structures are removed.

### SUMMARY OF THE INVENTION

A pet collar having an integrated audio playback system for easing the manner in which identification concerning a pet can be stored and retrieved. The audio message pet collar includes collar body constructed in substantially the same manner and of substantially the same materials as a conventional dog collar except that it includes an integrated electronics housing and speakers system. The electronics housing defines a waterproof case which includes a manually engagable electrical switch, a microphone, a controller, battery, sound card, and memory module. The controller is configured to, upon various engagements of the switch, enter a record mode or enter a playback mode, thereby enabling a pet caretaker to record desired information on the audio message pet collar, which subsequently be directly and quickly availed through an audible message to another in the event the pet is lost.

It is an object of this invention to provide a pet collar having an integrated audio playback system which would allow the playback of a informational message directly from the collar of a pet by any person who came across the pet.

It is another object of this invention to provide a pet collar having an integrated audio playback system which allows customized messages for playback to be selectively recorded by users so that playback could be customized over time.

It is yet another object of this invention to provide a pet collar having an integrated audio playback system that includes operative components which were built into the collar body, as opposed to being merely attached thereto.

These and other objects will be apparent to one of skill in the art.

### BRIEF DESCRIPTION OF THE DRAWINGS

FIG. 1 is a front perspective view of an audio message pet collar built in accordance with the present invention.

FIG. 2 is a back elevational view of an audio message pet collar built in accordance with the present invention with its electrical wires in phantom.

### DETAILED DESCRIPTION OF THE INVENTION

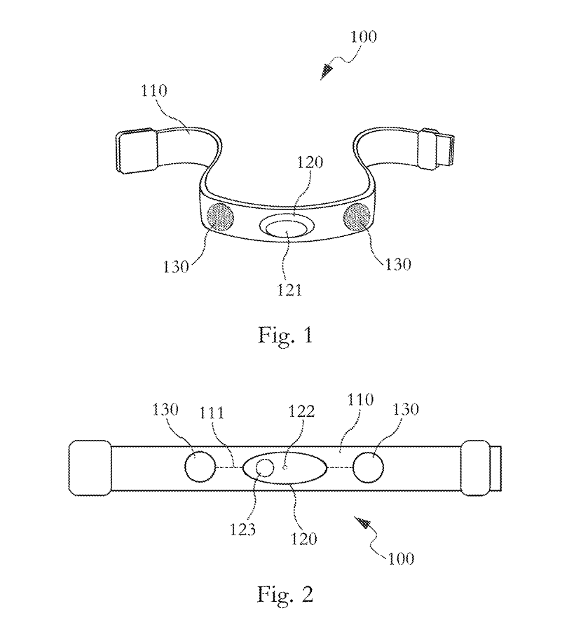

Referring now to the drawings and in particular FIGS. 1 and 2, an audio message pet collar 100 is shown having a collar body 110, an electronics housing 120, and two speakers 130. The collar body 110 is constructed in substantially the same manner and of substantially the same materials as a conventional dog collar, with the exception that the collar body 110 includes the electronics housing 120 and speakers 130 built into its material. Thus, in embodiments wherein the collar body is constructed of a fabric material, as illustrated in FIGS. 1 and 2, the electronics housing 120 and speakers 130, as well as the electrical wires 111 which connect the two, are woven/knitted into the fabric.

Conversely, in embodiments wherein the collar body 110 is constructed of a leather material, the electronics housing 120, speakers 130, and the electrical wires 111 are anchored and adhered to the collar body 110. In embodiments wherein the collar body 110 is constructed of a plastic or moldable material, the electronics housing 120, speakers 130, and the electrical wires 111 are either molded in or anchored and adhered to the collar body 110.

The electronics housing 120 defines a waterproof case which includes an actuator button 121 operative to engage an internal electrical switch, a microphone 122, and a battery compartment door 123, as well as an internal controller, battery, sound card, and memory module. The controller, switch, microphone, sound card, and battery are all electrically connected inside the electronics housing 120 and which are electrically connected to the electrical wires 111 which lead to the speakers 130. The controller includes software which allows it to, upon various engagements of the switch, to enter a record mode or enter a playback mode. The record more is defined by the controller causing any sound being received by the microphone to be processed by the sound card and stored as a data file on the memory module. The playback mode is defined by the controller causing a data file stored on the memory module to be processed by the sound card and broadcast by the speakers 130.

In the preferred embodiment, engaging the switch, by way of the button 121, for a period of five (5) seconds initiates the record mode while engaging the switch for a single second initiates the playback mode.

In use, it is appreciated that a pet caretaker can record their name, contact information, and any desired information concerning the pet on the audio message pet collar 100 such that if the pet is ever located by someone else, they can directly and quickly receive this information to facilitate the return of the pet.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A pet collar having an integrated audio playback system, comprising:
a collar body defining an elongated member having two opposing ends which are configured to be selectively fastened together;
at least one speaker integrated into said collar body; and
an electronics housing integrated into said collar body and electronically connected to said at least one speaker, wherein said electronics housing is configured to cause a stored audible message to be played on the speaker in response to manual actuation.

2. The pet collar having an integrated audio playback system of claim 1, wherein said electronics housing includes an integrated microphone and is configured to cause in response to manual actuation an audible message being received by the microphone to be stored.

3. The pet collar having an integrated audio playback system of claim 2, wherein said electronics housing includes an actuator button operative to receive manual actuation.

4. The pet collar having an integrated audio playback system of claim 1, wherein said electronics housing includes an actuator button operative to receive manual actuation.

5. The pet collar having an integrated audio playback system of claim 1, wherein said electronics housing and said at least one speaker each define discrete components integrated in separate locations on the collar body.
